(19) United States
(12) Patent Application Publication
(10) Pub. No.: US 2024/0242282 A1
(43) Pub. Date: Jul. 18, 2024

(54) PRIOR-INVESTMENT-TYPE PERFORMER ASSISTING SYSTEM

(71) Applicant: AKAmedia Japan Inc., Chuo-ku, Tokyo (JP)

(72) Inventor: Mairu KIKUCHI, Tokyo (JP)

(21) Appl. No.: 17/927,955

(22) PCT Filed: May 27, 2021
(86) PCT No.: PCT/JP2021/020159

§ 371 Date: May 23, 2023

(30) Foreign Application Priority Data
May 29, 2020 (JP) 2020-094041
Aug. 13, 2020 (JP) 2020-136630

(51) Int. Cl. G06Q 40/06; G06Q 30/08; H04N 21/218; H04N 21/2187; H04N 21/478

(52) U.S. Cl. CPC G06Q 40/06; G06Q 30/08; H04N 21/21815; H04N 21/2187; H04N 21/478

(57) ABSTRACT

Provided is a prior-investment-type performer assisting system with which, with respect to a performance presented by a performer, prior investment intended to obtain continuous dividends on later days can be made, and earnings are continuously allocated to the performer, too. A prior-investment-type performer assisting system 100 configured to be capable of communicating with a viewer terminal 302 includes a contribution acceptance unit 12 that, when an ad-hoc distributed performance is released in such a way that earnings are produced later on, accepts an application for purchase of a dividend right to the earnings, from the viewer terminal; and a dividend determination unit 15 that determines a dividend from the earnings with respect to the dividend right purchaser. When there are a plurality of dividend right purchasers, the dividend determination unit 15 determines the dividend based on the equity percentage of the dividend right of each purchaser. The equity percentage of the dividend rights is determined in accordance with a compensation for the dividend right purchase.

### TECHNICAL FIELD

The present invention relates to a prior-investment-type performer assisting system that enables to give monetary support by a contribution to a performance by an artist or the like.

### BACKGROUND ART

In recent years, a system for distributing a motion picture via the Internet has spread, allowing a variety of contents to be watched. In a conventional motion picture distribution system, a scheme of collecting a view charge from a viewer for each program has been proposed, in addition to a scheme of collecting a constant charge such as collecting a fixed charge every month (see, for example, Patent Document 1).

### PRIOR ART DOCUMENT

### Patent Document

Patent Document 1: JP-A-2001-309346

### SUMMARY OF INVENTION

### Problem to be Solved by the Invention

Recently, due to a recent world-wide prevalence of the new infectious disease, refraining from going outside or holding events with many people gathering has been requested to prevent the spread of the infectious disease, which resulted in an unprecedented state in which every live performance such as a concert or a theatrical play was canceled, causing people interested such as performers and so-called behind-the-scenes staff to have almost completely no income.

To break through this state, some artists release their performance by motion picture distribution on the Internet, to attempt to gain earnings through advertising revenue and electronic payment from motion picture viewers. With the existing scheme, however, it is difficult for a single performance to gain sufficient earnings. It is therefore desired to quickly establish a platform for allowing artists and the like to secure sufficient and sustainable earnings.

In light of the above-described problem, it is an object of the present disclosure to provide a prior-investment-type performer assisting system with which, with a performance being released on the Internet, a viewer who likes it can make prior investment intended to obtain continuous dividends on later days instead of paying a single view charge or support money, and earnings are continuously allocated to the performer, too.

### Means to Solve the Problem

In order to achieve the above-described object, the prior-investment-type performer assisting system of the present invention is configured to be capable of communicating with a viewer terminal via a network. This performer assisting system includes an ad-hoc distribution unit that distributes a performance in ad-hoc manner to a viewer terminal; a contribution acceptance unit that, when an ad-hoc distributed performance is released in such a way that earnings are produced later on, accepts an application for purchase of a dividend right to the earnings, from the viewer terminal; and a dividend determination unit that determines a dividend from the earnings with respect to the dividend right purchaser. When there are a plurality of dividend right purchasers, the dividend determination unit determines dividends based on the equity percentage of the dividend right of each purchaser. The equity percentage of the dividend right is determined in accordance with a compensation for the dividend right purchase.

### Effect of the Invention

The present invention makes it possible to provide a prior-investment-type performer assisting system with which it is possible to make prior investment intended to obtain dividends in future to an ad-hoc distributed performance, instead of paying a single view charge or support money to the performance. This makes it possible to pay, to a performer, at least a part of compensation that viewers paid when purchasing dividend rights, even in a situation where any real live performance with audience cannot be held. In addition, an ad-hoc distributed performance is released in such a way that earnings are produced later on, and at least a part of the earnings is allocated as dividends to the dividend right purchasers. In this way, the dividend right purchasers can obtain returns to the contributions. With the present system, therefore, both of a performer and a dividend right purchaser can continuously receive profits based on later release of a performance, instead of receiving profits only once upon ad-hoc distribution of the performance.

### BRIEF DESCRIPTION OF DRAWINGS

FIG. 1 is a block diagram illustrating a schematic configuration of a prior-investment-type performer assisting system according to Embodiment 1.

FIG. 2 illustrates an exemplary screen for viewing live relay broadcast (live relay broadcast viewing screen) displayed on a viewer's terminal.

FIG. 3 illustrates exemplary information to be stored in a data storage unit.

FIG. 4 is a block diagram illustrating a schematic configuration of a prior-investment-type performer assisting system according to Embodiment 2.

FIG. 5 illustrates exemplary information to be stored in a data storage unit.

FIG. 6 is a block diagram illustrating a schematic configuration of a prior-investment-type performer assisting system according to Embodiment 3.

FIG. 7 is a schematic diagram illustrating exemplary information registered in a performer registration unit.

FIG. 8 illustrates an exemplary live relay broadcast viewing screen displayed on a viewer's terminal.

FIG. 9 illustrates exemplary information to be stored in a data storage unit.

FIG. 10 is a block diagram illustrating a schematic configuration of a prior-investment-type performer assisting system according to Embodiment 4.

FIG. 11 is a sequence diagram illustrating a flow of determining a dividend right owner in the performer assisting system.

FIG. 12 is a block diagram illustrating a schematic configuration of a prior-investment-type performer assisting system according to Embodiment 5.

FIG. 13 illustrates an exemplary application screen displayed on a viewer's terminal in Embodiment 5.

### MODE FOR CARRYING OUT THE INVENTION

The following description describes embodiments of the present invention in detail, while referring to the drawings. Identical or equivalent parts in the drawings are denoted by the same reference numerals, and the descriptions of the same are not repeated.

### Embodiment 1

A prior-investment-type performer assisting system according to the present embodiment (hereinafter referred to as a “performer assisting system”) first performs ad-hoc distribution of a performance via the Internet. The “ad-hoc distribution” means a one-time distribution, or a distribution of a limited number of times or during a limited period. As an exemplary ad-hoc distribution in the present embodiment, an example is described in which a performance is distributed by live relay. As it is live relay broadcast, this distribution is a one-time distribution.

The performance as a target of investment (contribution) may be in any category and have any contents. In addition to public entertainments such as music performance, singing, disc jockey, theatrical play, musical, dance performance, magic trick show, Rakugo (comic storytelling), Manzai (comic dialogue), and conte, examples of the performance include various performances such as yoga, muscular exercise, various lessons such as cooking lesson, makeup lesson, fashion coordinate lesson, and kimono dressing lesson, as well as live cooking performed by restaurants.

Live relay broadcast of performances can be watched by any one for free, by using, for example, applications for browsing web contents and viewing motion pictures. Ad-hoc distributed live relay broadcast is recorded and stored. The recorded performance is distributed on later days in such a way that earnings are obtained, by using a recorded video distribution platform on the Internet. In the present embodiment, earnings associated with recorded video distribution are obtained from advertisement charges displayed on a viewing screen upon the distribution of the recorded video. Earnings may be obtained from charges for viewing motion pictures or charges for using applications, other than advertisement charges.

Incidentally, a viewer who has watched an ad-hoc distribution of a performance and likes it can make an application for a contribution in a fixed or arbitrary amount to the performance, as an angel (contributor). In other words, the ad-hoc distribution is distribution for recruiting angels. The application for a contribution from an angel can be made during live relay broadcast or within a predetermined time after the end of the live relay broadcast, by a viewer's terminal 302 on a screen for viewing live relay broadcast. This application for a contribution is equivalent to purchase of a right to receive a dividend from earnings associated with recorded video distribution (dividend right). In the present embodiment, an angel can arbitrarily determine a contribution amount, but the contribution amount may be fixed, or the scheme may be such that an angel purchases a desired number of units of a fixed-charge contribution. The angel can receive a dividend corresponding to the contribution amount (equity percentage of the dividend right) from earnings of recorded video distribution. An entirety or a part of contributions made by an angel, and a part of earnings associated with recorded video distribution are also allocated to a performer. With the above-described scheme, it is possible that a contribution to a performance during ad-hoc distribution of the performance is accepted from an angel, and a part of earnings obtained in association with recorded video distribution later on is returned as a dividend to the angel. In addition, a part of earnings associated with the recorded video distribution, in addition to at least a part of contributions, is allocated to the performer. The performer therefore can get not only a temporary income upon the presentation of the performance, but also a continuous income based on earnings generated on later days after the exhibition of the performance.

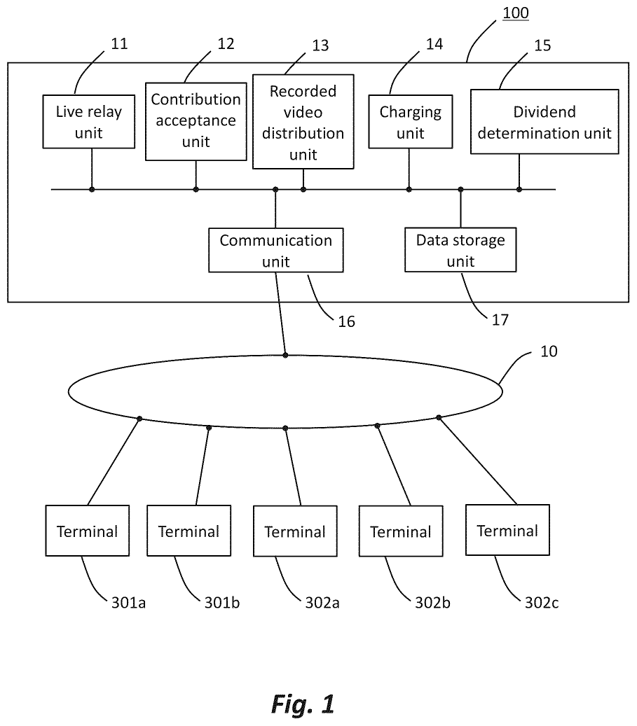

The following description describes the configuration and operation of the performer assisting system of the present embodiment to realize the above-described scheme. FIG. 1 is a block diagram illustrating a functional schematic configuration of the performer assisting system. As illustrated in FIG. 1, the performer assisting system 100 includes a live relay unit 11, a contribution acceptance unit 12, a recorded video distribution unit 13, a charging unit 14, a dividend determination unit 15, a communication unit 16, and a data storage unit 17. Incidentally, functions of these units are realized by a processor of a computer executing a program. Each unit may be mounted on one server, or may be dispersed and mounted on a plurality of servers.

The performer assisting system 100 is communicable with a terminal 301 (terminals 301a, 301b, . . . ) of a performer and a viewer's terminal 302 (terminals 302a, 302b, 302c, . . . ) via a network 10 such as the Internet. Each of the terminal 301 and the terminal 302 can be configured with an arbitrary hardware such as a smartphone, a tablet, or a personal computer. Incidentally, in FIG. 1, for convenience of explanation, the terminals of the performers and the terminals of the viewers are shown separately, but one and same person can be a performer, and at the same time a viewer that watches a performance of another performer.

The live relay unit 11 receives a motion picture of a performance from the performer's terminal 301, and executes live relay broadcast. Here, the live relay unit 11 relays received pictures, and at the same time, stores recorded video of live motion pictures in a storage device inside or outside the live relay unit 11. A viewer can make access from the terminal 302 to the live relay unit 11 via the network 10 to watch live relay broadcast for free.

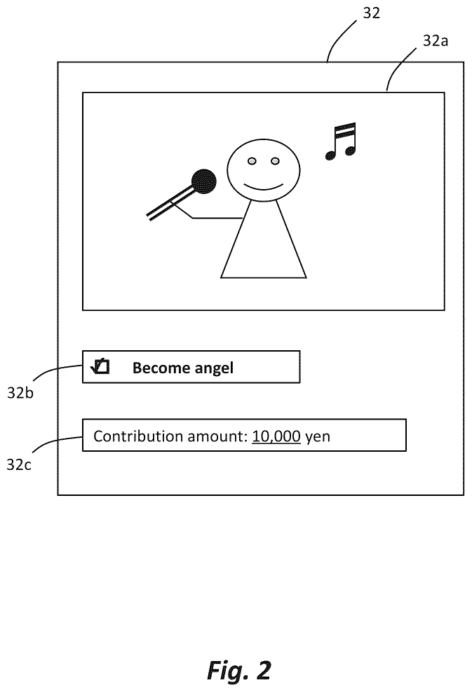

While live relay broadcast is being executed, a live relay broadcast viewing screen 32 as shown in FIG. 2 is displayed on the terminal 302. In the example shown in FIG. 2, a selection field 32b for a viewer making selection on whether to make a contribution to this performance as an angel, and an amount entry field 32c for the viewer entering an amount of the contribution, along with a live relay broadcast image 32a of the performance, are displayed on the live relay broadcast viewing screen 32. The viewer enters a check in the selection field 32b when he/she wants to make a contribution to this performance as an angel, and freely enters an amount of the contribution in the amount entry field 32c. In the example shown in FIG. 2, “10,000” yen is entered as an amount of the contribution. Incidentally, the performer's profile, comments, and the like may be displayed on the live relay broadcast viewing screen 32, making the screen effective for attracting the interest of viewers. In addition, the number of angels at the moment and the total amount of contributions from angels may be displayed on the live relay broadcast viewing screen 32. The display and the like of the live relay broadcast viewing screen 32 on the terminal 302 are controlled by application programs downloaded to the terminal 302 and executed therein. Alternatively, the display and the like of the live relay broadcast viewing screen 32 may be executed by utilizing Saas (Software as a Service) provided by the performer assisting system 100 via a browser of the terminal 302

The entry of a contribution amount is allowed by the end of live relay broadcast. Making a contribution may be allowed even after the end of live relay broadcast, until a predetermined period of time has passed. Incidentally, in the present embodiment, a user registration is required, in order that the terminal 302 is caused to display the live relay broadcast viewing screen. The user registration may be under a real name or an anonym. It is however necessary to acquire login information that uniquely identifies a viewer (viewer ID, password, etc.), and information required for electronic payment. In this way, by causing a viewer to make user registration in advance, viewers who have made contributions (purchases of dividend rights) can be uniquely identified. Incidentally, as the login information, login information of other systems (SNS, OS, various types of application programs, etc.) can be commonly used. Incidentally, as to a performer, similarly, a performer ID for identifying a performer is assigned to each performer. It should be noted that an ID may be commonly used as a viewer ID and a performer ID.

When a contribution amount is entered on the live relay broadcast viewing screen, contribution amount data together with information identifying the viewer are sent from the terminal 302 to the contribution acceptance unit 12. An amount of the contribution from an angel is collected by electronic payment from the angel making the contribution, and an entirety or a part of the amount is paid to a performer as a compensation for the presentation of the performance (performance fee) by live relay broadcast.

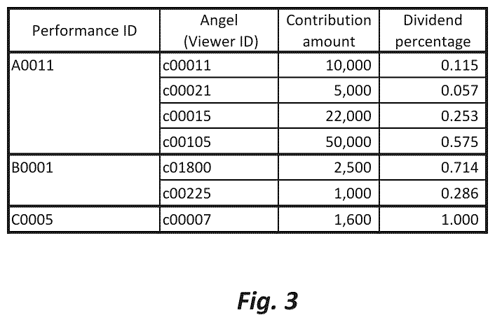

The contribution acceptance unit 12, when receiving information that identifies the angel (viewer) and contribution amount data from the viewer's terminal 302, stores the same, together with information that identifies the performance as a contribution target (performance ID), in the data storage unit 17. The performance ID is an ID uniquely assigned to each performance by the system. FIG. 3 illustrates exemplary information to be stored in the data storage unit 17. In the example shown in FIG. 3, angels with respect to three performances, and respective contribution amounts made by the angels are stored. In addition, respective dividend percentages for the angels are also stored in the data storage unit 17. The dividend percentage is calculated by the contribution acceptance unit 12 after the application for a contribution is concluded, and is stored in the data storage unit 17. In other words, this dividend percentage represents each angel's equity percentage of the dividend right.

The recorded video distribution unit 13, as a motion picture distribution platform, distributes the recorded performance video. The performer has to register recorded video for distribution in the recorded video distribution unit 13 during a predetermined period of time after the end of the live relay broadcast. The recorded video for distribution may be the motion picture of the live relay broadcast performance itself, or may be a motion picture that has been edited in a certain way by the performer. The performer, when editing the recorded video, can download the recorded performance video from the live relay unit 11 to the performer's terminal 301, and upload the edited motion picture to the recorded video distribution unit 13. Alternatively, after a predetermined period of time has passed, irrespective of whether it has been edited or not, the motion picture recorded by the live relay unit 11 may be registered forcibly in the recorded video distribution unit 13. The registered recorded performance video is recorded in a storage device inside or outside the recorded video distribution unit 13.

A viewer can watch the recorded performance video at the terminal 302 for free. It should be noted that upon the reproduction of the recorded performance video, advertisement is also displayed together, and advertising revenue from an advertiser according to the view count of the recorded performance video goes to the recorded video distributor. Upon every access to the recorded video distribution unit 13 for watching one recorded performance video, the charging unit 14 increments the view counter of the recorded performance video by one. The charging unit 14 calculates a revenue of recorded video distribution at a predetermined timing (for example, the last day of every month) per recorded performance video, by multiplying the view count in a target period by an advertisement unit price. Incidentally, the method for calculating the revenue of recorded video distribution is not limited to this, and any method such as a calculation method taking customer appeal of advertisement into consideration can be used.

The revenue of recorded video distribution thus calculated is collected from an advertiser. At least a part of the revenue of recorded video distribution is divided among the performer and the angel. The ratio of the division (division ratio) between the performer and the angel is preliminarily determined to be a predetermined ratio or a ratio according to a predetermined rule. For example, regarding one recorded performance video, 50% of the revenue of recorded video distribution may be paid to the performer, and the rest 50% may be paid to the angel. Alternatively, for example, the division ratio among the performer and the angel may vary according to the amount of the revenue of recorded video distribution, according to a predetermined rule. Incidentally, a part of the revenue of recorded video distribution may be allocated to a third party other than the performer and the angel (for example, a manager of the performer assisting system).

When there are a plurality of angels for one recorded performance video, the dividend determination unit 15 divides the revenue of recorded video distribution allocated to the angels according to the respective equity percentages of the dividend rights of the angels (dividend percentages), thereby determining the amounts of the dividends. For example, according to the example shown in FIG. 3, the dividends to the angels from the revenue of recorded video distribution as to a performance with a performance ID of A0011 are divided at 11.5%, 5.7%, 25.3%, and 57.5% and paid to four angels, respectively. Regarding a performance with a performance ID of C0005, there is only one angel. This angel therefore receives the total amount of the dividend from the revenue of recorded video distribution to angels. In this way, each angel can receive a dividend corresponding to the percentages of the contributions in an equitable manner.

Though the recorded video can be watched for free and the revenue of recorded video distribution is based on advertising revenue in the above-described example, the watching of the recorded video may be charged and the view charge may be allotted to the revenue of recorded video distribution. In addition, though anyone can watch the live relay broadcast for free in the above-described example, the watching of the live coverage may be charged. In this case as well, an entirety or a part of the view charge of live relay broadcast can be allocated to the performer.

In addition, though an angel makes a monetary contribution in the above-described example, an angle may make a contribution with points that have equivalent value to money and can be used in the present system and/or compatibly used in another system.

In addition, as a configuration of the above-described example, a configuration is shown in which the performer assisting system 100 incorporates the recorded video distribution unit 13 inside. The configuration, however, may be such that the performer assisting system 100 does not have any function of the recorded video distribution unit 13 and outsources the recorded video distribution to an outside motion picture distribution platform. For example, by outsourcing recorded video distribution to a large-scale motion picture distribution platform such as YouTube (registered trademark), the expected number of viewers is significantly increased, which enables to increase earnings by recorded video distribution and makes the performer's name better known. In this case, the performer assisting system 100 receives data of earnings based on the distribution of respective recorded performance videos, and calculates dividends to the performer and the angel in the dividend determination unit 15.

As is described above, with the performer assisting system 100 of the present embodiment, when viewers who have viewed live relay broadcast performances on the Internet make contributions to performances that they like as angels, an entirety or a part of the contribution amounts is paid to the performers as performance fees, and in addition, on later days, at least a part of the revenue of distribution of recorded live relay broadcast is divided among the angels. In addition, the revenue of recorded video distribution is also allocated to the performers. Therefore, the performers receive not only performance fees of live relay broadcast, but also continuously receive earnings based on the recorded video distribution on later days, thereby being allowed to earn stable income based on performances. In addition, the angels can receive dividends corresponding to the respective contribution amounts from the revenue of recorded video distribution, which means that they can get return to their support to the performers. Particularly, since angels, when searching for a performer as a contribution target, have a psychological tendency of making contributions to a perform who is talented but less known and has few contributors, the present system has an excellent effect of bringing attention to new talents and leading to the talent picking up. In other words, the performer assisting system 100 of the present embodiment also has a function as a platform on which a new talent will distinguish him/herself.

Conventionally, crowdfunding has often been used as a scheme for assisting performers. In the case of crowdfunding, however, return (compensation or return present) to contributors has to be thought out and presented every time, which is bothersome. Besides, when the funding is not accomplished or the project cannot be continued for a certain reason, contributors cannot obtain return in some cases. In addition, generally contributors obtain the return only once.

In contrast, the performer assisting system 100 of the present embodiment, a one-time performance (live relay broadcast) is associated with a place (the recorded video distribution unit 13 or an outside motion picture distribution platform in the above-described example) where the performance results in a recorded performance video and generates continuous earnings, and contributors (angels) can continuously receive a part of the earnings generated therefrom as a compensation or a return present. Besides, dividends from earnings are allocated to angels according to their respective contribution amounts in an equitable manner.

Incidentally, in the above-described example, a scheme is shown in which a recorded vide of a live relay broadcast performance is created, and is distributed on later days on a motion picture distribution platform, whereby earnings are generated from advertising revenues and view charges. The place where earnings are generated, however, is not limited to the recorded video distribution platform on the Internet, but may be a real place such as a gallery, an exhibition hall, a concert hall, a theater, or a movie theater. In this case, an admission fee, a sponsor fee by an advertiser, and the like can be earnings. In addition, a photo sharing site, an EC site, or the like can be a place where earnings are generated, depending on contents of a performance.

Conventionally, a scheme also has been known in which a viewer provides a monetary compensation called “Nagesen (tossed coin, or tipping)”, a charged gift, etc. to an artist who distributes a performance on the Internet. Such a “Nagesen” system, however, does not continuously provide dividends, since “Nagesen” can be made to a performer only during live coverage. Any return is not generated to a viewer who made “Nagesen”, either.

In contrast, the performer assisting system 100 of the present embodiment has the following circulation function: in a case where payment from a viewer is made in the form of contribution to live relay broadcast, earnings are to be generated on later days by distribution of recorded live relay broadcast to which the payment is made, and the generated earnings are to be returned to the contributor (angel). In this viewpoint as well, the performer assisting system 100 has an effect that the conventional “Nagesen” system does not have.

Incidentally, though contents of ad-hoc distribution are live relay broadcast of a performance in the above-described example, the contents of ad-hoc distribution are not limited to live relay broadcast. For example, a recorded video of a concert or a live performance (unreleased one), a video work such as a drama or a cinema (unreleased work) may be presented by ad-hoc distribution to recruit angels. After the end of the ad-hoc distribution, these contents are released on a motion picture distribution platform on the Internet or a theater in such a way that earnings are produced. The earnings are then divided among those who are engaged in the creation of the contents (for example, though not limited to, a production company, a movie director, a scriptwriter, a producer/director, a performer, etc.) and an angel.

In addition, in the example shown in the above description, a performance can be detected by visual recognition, and the release of this performance in such a way that earnings are produced later on is the release by recorded video distribution. In a case of a performance of music or reading aloud, however, the later release of the same may be the reproduction of a recorded sound source on a music reproduction platform or the like.

### Embodiment 2

The following description describes Embodiment 2 of the present invention. The constituent elements having the same functions as those in the above-described embodiment are denoted by the same reference symbols, and detailed descriptions of the same are omitted. This also applies to other embodiments described below.

In Embodiment 1, an angel is a general viewer, and compensation (dividends) of a contribution is funded by an advertising revenue associated with recorded video distribution or a view charge for a recorded video. In Embodiment 2, an advertiser who wants to put an advertisement in recorded video distribution is an angel, and a frequency of advertisement appearance in a distributed recorded performance video is determined according to the equity percentage of the dividend right. In other words, in the present embodiment, a right for displaying an advertisement during the reproduction of a recorded performance video is given as a dividend right to an advertiser who is an angel. Incidentally, in the present embodiment as well, the advertiser as an angel can enter a contribution amount on a live relay broadcast viewing screen, during live relay broadcast, or after the end of the live relay broadcast until a predetermined period of time has passed.

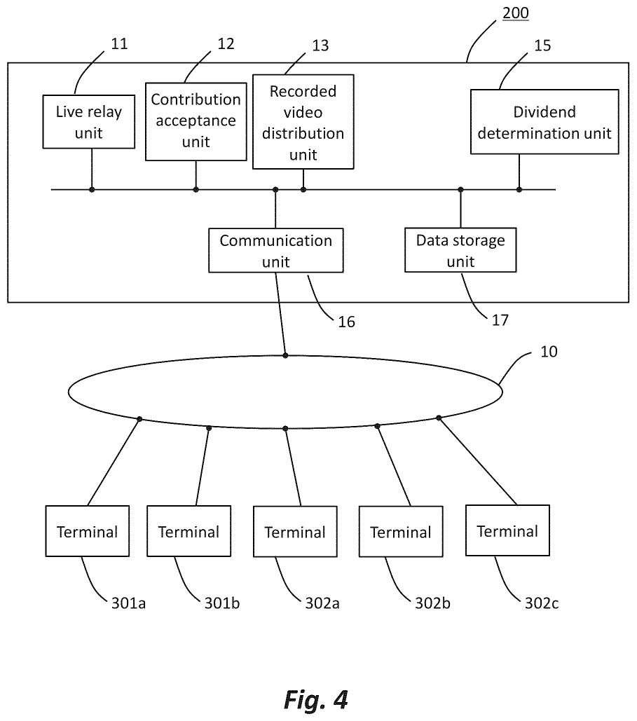

FIG. 4 is a block diagram illustrating a functional configuration of the performer assisting system 200 according to the present embodiment. As illustrated in FIG. 4, the performer assisting system 200 does not include the charging unit 14, and includes a dividend determination unit 25 in place of the dividend determination unit 15. The dividend determination unit 25 determines how many times each angel's advertisement is displayed (display frequency) during the reproduction of a recorded performance video, according to the dividend percentage determined in accordance with the amount of a contribution that the angel made. In addition, the performer assisting system 200 includes an advertisement management unit 24. The advertisement management unit 24 inserts each angel's advertisement in the recorded performance video distributed by the recorded video distribution unit 13, according to the display frequency determined by the dividend determination unit 25.

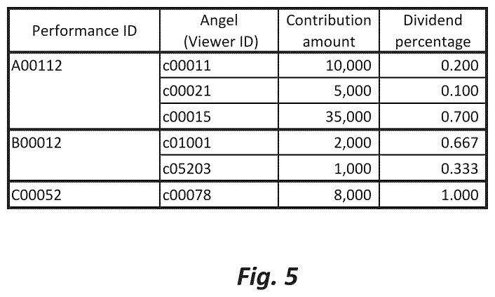

Here, as illustrated in FIG. 5, it is assumed that there are three angels with respect to a performance having a performance ID of A00112. These angels are all advertisers who want to insert advertisements when the recorded video of the performance A00112 is distributed. The dividend percentages of the three angels are 20%, 10%, and 70%, respectively, according to the respective contribution amounts, as shown in FIG. 5. In this case, the dividend determination unit 25 sends the advertisement management unit 24 an instruction to make the frequencies of appearance of the three angels' advertisements 20%, 10%, and 70%, respectively.

The advertisement management unit 24, receiving the above-described instruction, sends the recorded video distribution unit 13 an instruction to, for example, display the advertisement of the angel c00011 twice, display the advertisement of the angel c00021 once, and display the advertisement of the angel c00015 seven times while a recorded video is distributed ten times successively.

In addition, in every predetermined period (for example, every month), the advertisement management unit 24 counts the view count of the recorded performance video in which the angels' advertisements are inserted by the recorded video distribution unit 13. Then, the advertisement management unit 24 calculates advertisement charges according to the numbers of view, and collects the same from the respective angels as advertisers. An entirety or a part of revenue of the collected advertisement charges is allocated to the performer as earnings.

With the above-described configuration, with the performer assisting system 200, an advertiser, as an angel, can select a performance to which he/she wants to insert an advertisement, and make a contribution. The advertiser, therefore, can select a performance that has an impression or a view of the world that is suitable for the advertisement of the advertiser's goods or service, as a site for placement of an advertisement.

In addition, as at least a part of advertising revenue goes to the performer as earnings, the performer can continuously receive earnings based on the recorded video distribution after live relay broadcast.

In addition, the relationship between a performer assisting system and an advertiser in the performer assisting system 200 is different from the conventional one, and there is the following advantage for the performer. For example, conventional schemes in television programs by ground-wave digital broadcasting, program broadcasting using the Internet, and the like are generally established by broadcast stations that produce programs and distribute the same, sponsors that want to place their advertisements in the programs, as well as performers appearing in the programs or agencies that provide performers. A guaranteed fee (performance fee) for a performer is determined by negotiations between a broadcast station and the performer (agency) according to the past fees for the performer, and an audience rating expected to be achieved by the appearance of the performer.

In contrast, in the performer assisting system 200, a sponsor that likes a live relay broadcast performance as a site for placement of an advertisement applies for a contribution to the performance, and an advertisement display frequency in the recorded video to be distributed on later days is determined according to an equity percentage of a dividend right. In other words, advertisement display in the distributed recorded video is allocated as a compensation or return to the contribution. Further, for the performer, such a conventional trouble that the performer is forced to agree with a disproportionate fee decided by the agency he/she belongs to, or that a performance fee is not paid to the performer, can be prevented since earnings funded by an advertising revenue are allocated to the performer. Still further, as a compensation in correspondence to the value or evaluation of the performance is directly given to the performer, the performer can lay more stable foundation for life and can expect improvements in the environments and conditions for creation and performance activities.

### Embodiment 3

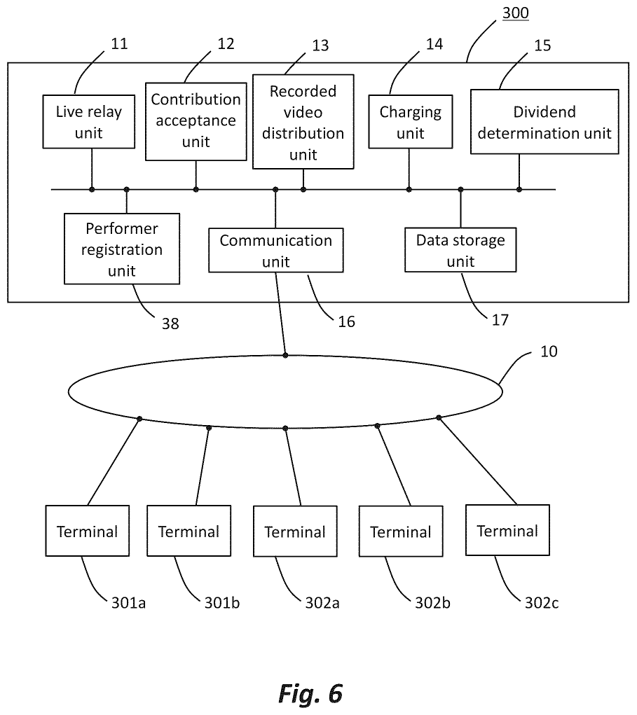

In the description of the present embodiment, a performer assisting system is described in which when there are a plurality of performers in one group such as a band, a theatrical company, or an idol group, a viewer can select a particular performer and makes a contribution to him/her. A performer assisting system 300 of the present embodiment is different from the performer assisting system 100 in Embodiment 1 in that a performer registration unit 38 is provided, as shown in FIG. 6.

In the performer assisting system 300, before ad-hoc distribution (assumed herein to be live relay broadcast of a band performance) is started, for example, a band leader or a manager (inviter) first creates an account of the band, and then, sends an invitation from his/her own terminal 301 to all band members' terminals 301. Each member holds his/her own individual account on the performer assisting system 300, and the invitation is sent from the inviter's terminal 301 to the respective individual accounts of the members.

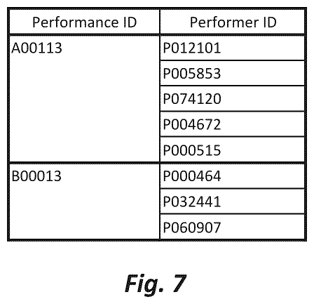

When the member receiving the invitation operates the terminal 301 to “accept” the invitation, the account ID of the member is sent from the terminal 301 to the performer registration unit 38, and the account ID is registered as a performer ID. FIG. 7 is a schematic diagram illustrating exemplary information registered in the performer registration unit 38. As illustrated in FIG. 7, as to each performance, a plurality of performers that give the performance are registered. For example, here, it is assumed that a certain band is composed of five members, and is going to give a performance (live relay broadcast of a band performance) to which a performance ID of A00113 shown in FIG. 7 is assigned.

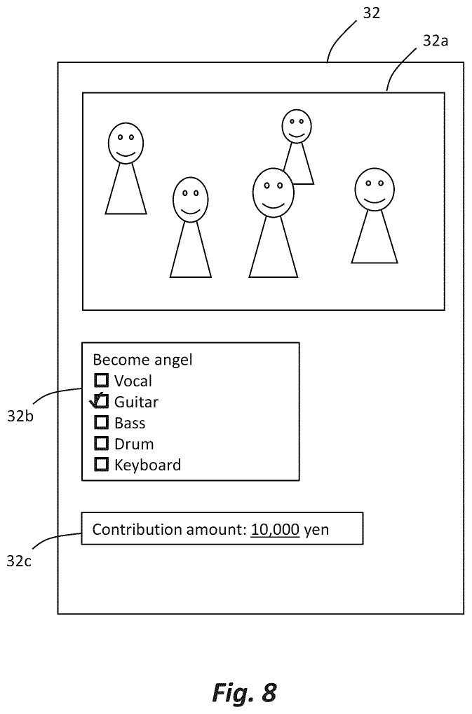

Then, upon the start of ad-hoc distribution of the band performance by live relay, as is the case with Embodiment 1, a viewer who watches this live relay broadcast on the terminal 302 can apply for a contribution as an angel. Unlike in Embodiment 1, however, buttons for selecting a band member as a contribution target are displayed in a selection field 32b of a live relay broadcast viewing screen 32, as illustrated in FIG. 8. A viewer who wishes to make a contribution as an angel selects a member as a contribution target in the selection field 32b, and enters an amount of the contribution in the amount entry field 32c. Incidentally, the configuration may be such that a plurality of members can be selected simultaneously in the selection field 32b, and respective amounts of contributions for the members may be entered separately. The contribution acceptance unit 12, when receiving such entries from the viewer's terminal 302, stores information that identifies the angel and information that identifies the performance as a contribution target (performance ID) by associating the same with each other, in the data storage unit 17.

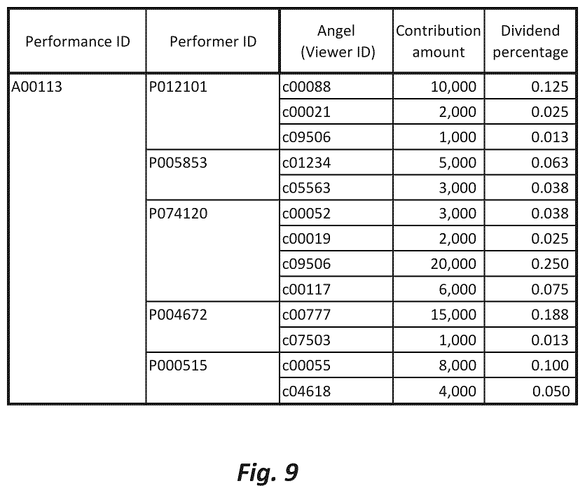

FIG. 9 is a schematic diagram illustrating exemplary data relating to this performance (performance ID: A00113), stored in the data storage unit 17 in the performer assisting system 300. In the example shown in FIG. 9, there are a plurality of angels with respect to each of the five band members (performers). In the present embodiment as well, an ad-hoc distributed performance (live relay broadcast of a band music performance) is recorded, and is distributed on a motion picture distribution platform on later days in such a way that earnings are produced. As is the case with Embodiment 1 or 2, earnings of recorded video distribution are funded by view charges and advertisement charges, and the earnings are allocated to the band account, the respective accounts of the band members, and the dividend right owners (angels). For example, 15% of the earnings of recorded video distribution is allocated to the band account, 35% of the same is allocated to the accounts of the band member individuals, and 50% of the same is allocated to the angels. In this case, the 50% of earnings allocated to the angels are further divided based on the dividend percentages (equity percentages of the dividend right) shown in FIG. 9, and are allocated to the angels, respectively. In addition, the allocation ratio for the band member individuals may be determined based on the respective percentages of the contributions from the angels to the members.

As described above, with the present embodiment, in a case of a performance made by a plurality of performers, a viewer can make a contribution by designating a performer he/she likes. In addition, as described above, by determining the allocation ratio for the respective band members based on the respective percentages of the contribution amounts from the angels, a more popular band member (a member to which a more contribution is made by angels) can get a greater allocation, which enables profit allocation with feeling of equitability.

Incidentally, in the present embodiment, by making the allocation ratio for the respective band members (i.e., each member's contribution amount percentage) non-disclosed to the band account and the band members, the band members by no means know the profit allocation one another. This makes it possible to protect privacy regarding profits among the band members, thereby also achieving an advantage that a conflict over profit allocation can be prevented from occurring.

Incidentally, in the above-described example, a leader or a manager of a band creates an account of the group as a whole (band account), and outputs an invitation (participation request) to the band members, but the creator of the group account is not limited to this, but may be anyone. For example, the configuration may be such that a facility service company for a facility that can be a place where a performance is released, such as a live house or a theater, creates a group account, and outputs an invitation (participation request) to a performer (a group or an individual) that presents a performance using the facility. As an example of the facility service company, in addition to the above-mentioned live house or theater, the following can be thought of, though not limited to: event venues, concert halls, rental studios, rental spaces, and karaoke halls. According to the present embodiment, earnings are also allocated to these facility service companies, which makes it possible to ensure earnings for the companies even if the companies are requested to refrain from operating due to the new infectious disease.

### Embodiment 4

In Embodiments 1 to 3, among viewers of ad-hoc distribution, all of those who have applied for contributions as angels can acquire the dividend right. In Embodiment 4, in contrast, applications for contributions are subjected to a two-stage auction so that dividend right owners are determined. Details of this two-stage auction are described in Japanese Patent No. 6664726 based on the prior application (JP-A-2019-165679) of the applicant of the present application, the entire content of which is incorporated herein by reference.

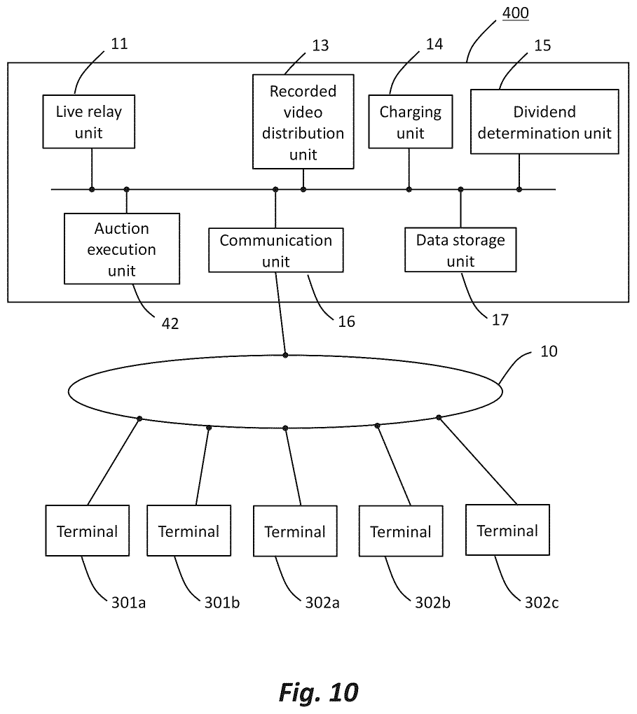

As illustrated in FIG. 10, a performer assisting system 400 according to Embodiment 4 includes an auction execution unit 42 in place of the contribution acceptance unit 12. The auction execution unit 42 executes a two-stage auction with respect to an application for a contribution from a viewer of ad-hoc distribution so that dividend right owners are determined.

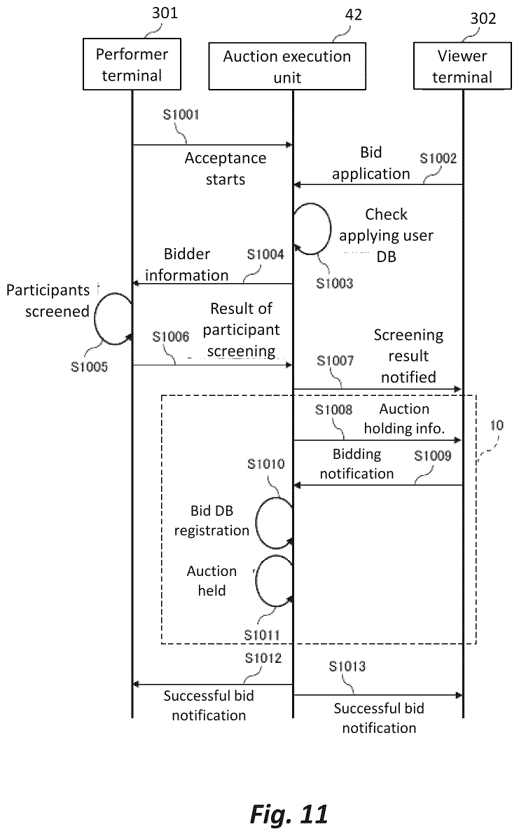

FIG. 11 is a sequence diagram illustrating a flow of determining a dividend right owner in the performer assisting system 400. Incidentally, here, ad-hoc distribution is assumed to be live relay broadcast of a performance. When the ad-hoc distribution is started, a video image of the live relay broadcast is sent to the live relay unit 11, and as shown in FIG. 11, a signal that instructs a start of accepting contribution application is sent from the performer terminal 301 to the auction execution unit 42 (Step S1001).

The auction execution unit 42, when receiving the accept start signal, receives an application for a contribution (bid application) from the viewer terminals 302, while ad-hoc distribution is being carried out, or until a predetermined period has passed since the end of the ad-hoc distribution (Step S1002). Upon reception of a bid application, the auction execution unit 42 checks a database of registered users of the performer assisting system 400 (Step S1003), and sends the bidding amount (contribution amount) included in the bid application and bidder information extracted from the registered user database to the performer terminal 301 (Step S1004).

Thereafter, in the performer terminal 301, the performer screens the bid participants based on the bidding amounts and the bidder information (first-stage auction), to determine qualifiers (Step S1005). The criteria for screening in the first-stage auction can be arbitrarily set by the performer. In other words, all bidders that satisfy the minimum criteria such as not appearing in a black list may be qualified, or an upper limit and/or a lower limit may be set to the bidding amount (contribution amount). By appropriately setting the criteria for screening in the first-stage auction, bidders with a too high/low bidding amount can be excluded and the like, whereby mischievous bidding can be prevented.

The result of the first-stage auction (participant selection result) is sent from the performer terminal 301 to the auction execution unit 42, and is stored in a storage device inside or outside the auction execution unit 42. Based on the participant selection result, the auction execution unit 42 sends a notification to the terminals 302 of the viewers who have gone through the first-stage auction, notifying that they have passed the screening (Step S1007). Here, to the viewers who have not passed the screening, such notification may be sent, too.

Thereafter, the second-stage auction is carried out among bidders having gone through the first-stage auction alone. The second-stage auction is carried out after the ad-hoc distribution ends. The auction execution unit 42 sends the second-stage auction holding information exclusively to the terminals 302 of the bidders having gone through the first-stage auction (Step S1008). The second-stage auction holding information includes, for example, the lowest successful bid price, the bid end time, and the bid amount entry field. Incidentally, the holding of the second-stage auction can be seen by all viewers, from the terminals 302 connected to the performer assisting system 400. The process (bid state) of the second-stage auction, however, can be viewed from the terminals 302 by only the participants in the second-stage auction, that is, by only those who have received the second-stage auction holding information, and cannot be viewed by the others.

The bidders who have received the second-stage auction holding information make bids through the terminals 302 (Step S1009). The bidder may enter, as a bid amount, an amount different from the contribution amount that he/she entered at a time during the ad-hoc distribution. The auction execution unit 42 registers a bid notification sent from a bidder's terminal 302, in a bid DB (not shown) (Step S1010).

Thereafter, the auction execution unit 42 executes the second-stage auction based on the bid information registered in the bid DB (Step S1011). Incidentally, the bid DB is updated from time to time whenever the auction execution unit 42 receives a bid notification during an auction holding period. At the terminal 302 of a bidder of the second-stage auction, the bidding screen is updated from time to time according to the bid state. The bidder, seeing the bid state on the terminal 302, can rebid by changing the bidding amount, if it is during the bid period. This process from Step S1008 to Step S1011 is repeated until the auction ends (Loop 10). When the bid period ends, the auction execution unit 42 ends the auction by stopping the acceptance of a new bid.

The auction execution unit 42 also determines the successful bidder of the dividend right according to predetermined conditions. For example, among the bids registered in the bid DB, the predetermined number of bidders are determined to be successful bidders in a suggested bid amount descending order. In other words, the successful bidders here determined can get the dividend right. In addition, the dividend from earnings of the performance is determined according to the equity percentage of the dividend right calculated based on the bid amount in the second-stage auction. Incidentally, who are the successful bidders and the bid amounts of the successful bidders are disclosed to only the bidders of the second-stage auction, and are not disclosed to the others.

When the successful bidders are determined, a successful bid notification is sent from the auction execution unit 42 to the performer's terminal 301 (Step S1012). The auction execution unit 42 also sends the successful bid notification to the successful bidders' terminals 302 (Step S1013). Incidentally, here it is assumed that the auction execution unit 42 automatically determines successful bidders by referring to bid amounts, but the configuration may be such that the performer him/herself determines successful bidders.

As described above, with the performer assisting system 400 of Embodiment 4, among viewers who have applied for contributions as angels, only those who are determined to be successful bidders through the two-stage auction can acquire the dividend right. In a case where the number of angels is to be limited for a certain reason, it is the best policy to utilize this scheme. This is because, with the two-stage auction of the present embodiment, bidders who can participate in the second-stage auction can be narrowed down through the first-stage auction based on the first bidding. Further, the second-stage auction is carried out among the bidders qualified for the participation in the second-stage auction, and the contents of the second-stage auction are not disclosed. This scheme is particularly advantageous in a case where the disclosure of the successful bidders and the successful bid price are undesirable. For example, in a case of an artist such as a singer, an instrument player, and a dancer, as well as a professional entertainer, if angels are determined in a common auction style and their contribution amounts (bid amounts) are clarified, there arises a problem that the de facto price is established regarding the guaranteed fee (performance fee) for the artist (the performance fee is fixed or standardized). For artists and professional entertainers, it is preferable that a performance fee and the like can be flexibly set according to a situation. Therefore, by applying the two-stage auction when contributors (angels) for a performer are determined, concealing the successful bid price is enabled, and the performance fee and the like can be prevented from becoming fixed.

### Embodiment 5

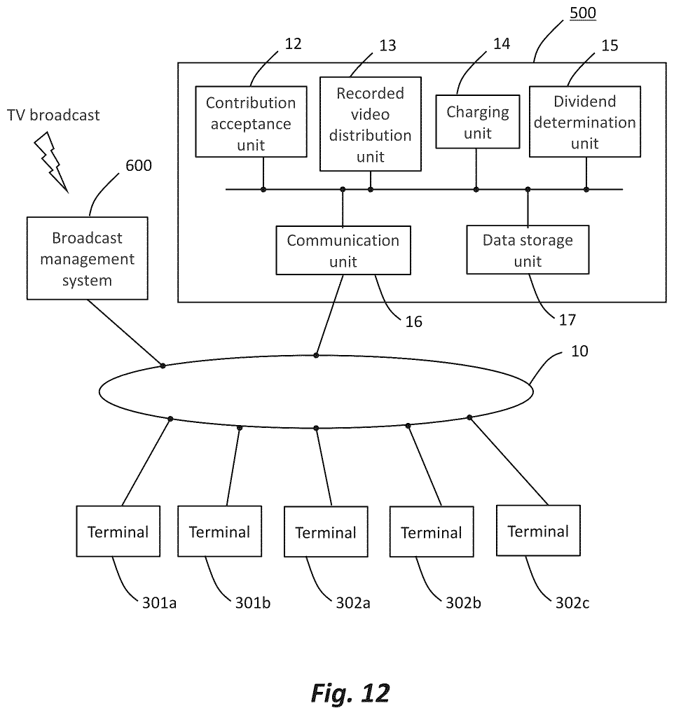

Embodiment 5 relates to a performer assisting system operating in a linked manner with television programs. FIG. 12 illustrates a schematic configuration of a performer assisting system 500 according to Embodiment 5. As shown in FIG. 12, the performer assisting system 500 is different from, for example, the performer assisting system 100 of Embodiment 1 described above in that it does not include the live relay unit 11.

In other words, in the present embodiment, the ad-hoc distribution for recruiting contributors is broadcast, not from the performer assisting system 500, but as a television program from a broadcast management system 600 of a television broadcast station (television station). This television program can be configured as, for example, a new face scouting audition program, but may be live relay broadcast, or reproduction of a recorded video. A performer may go to a studio such as a television station to make a performance, or a performance shot by a performer at home or at a desired place may be sent to a television station and broadcast by live relay by the television station. Alternatively, a performance, video of which is sent by a performer and edited by a television station, may be broadcast. This television program is watched on a television receiver generally, but may be watched on the viewer's terminal 302. Incidentally, in the following description of a specific example, a case is described in which a viewer, watching ad-hoc distribution broadcast as a television program on a television receiver, makes an application for purchase of a dividend right, by using the terminal 302.

In the present embodiment, as shown in FIG. 12, the performer assisting system 500 can be connected with the broadcast management system 600 of the television station via a network 10. It should be noted that the ad-hoc distribution of a performance is made viewable on a television receiver through the television broadcast network, as described above. In other words, the ad-hoc distribution (television program) of a performance in the present embodiment is not distributed to a viewer's terminal 302 via the network 10. Here, the television broadcast network may be any of a grand-wave broadcast network, a satellite broadcast network, and a wired (cable) broadcast network. Incidentally, in FIG. 12, only one broadcast management system 600 of a television station is shown, but the performer assisting system 500 can be connected with systems of a plurality of television stations.

The broadcast management system 600 sends schedule information of a television program of a performance to the performer assisting system 500 via the network 10. The schedule information includes the ID for identifying the television station, the broadcast time zone of the television program, the title of the television program, the names of performers appearing in the television program, and the time zone in which the performance is presented. This makes it possible to obtain information regarding in which channel and when the television program of the performance is broadcast, etc., on the performer assisting system 500.

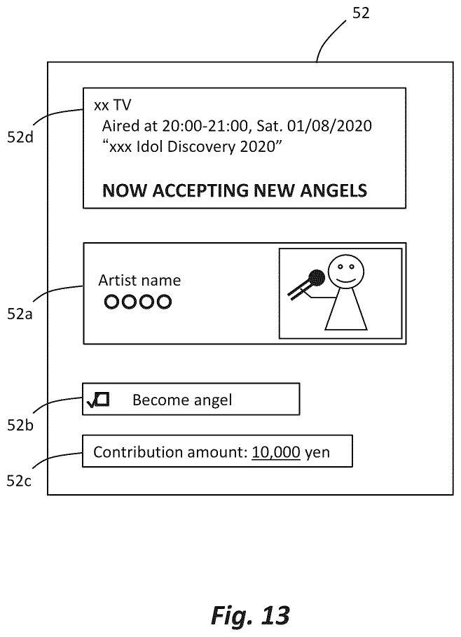

A viewer, watching the performance on a television receiver, can make an application for purchase of a dividend right, by operating the terminal 302. In the present embodiment, an application screen 52 as shown in FIG. 13 is displayed on the terminal 302. This application screen 52 may be displayed by an application program installed in and executed by the terminal 302, as is the case with the live relay broadcast viewing screen 32 of Embodiment 1 described with reference to FIG. 2. Alternatively, it may be displayed by SaaS provided by the performer assisting system 500. Incidentally, while the television program is being broadcast, a QR code (registered trademark) or the like for reading may be displayed in a part of the screen of the television receiver, and the application screen 52 for the television program may be displayed on the terminal 302 when the terminal 302 reads the QR code. Alternatively, the configuration may be such that a television program table is displayed on the terminal 302, and when on the terminal 302a viewer selects a program that he/she wants to watch, the application screen 52 of the selected program is displayed on the terminal 302.

As shown in FIG. 13, the following are displayed on the application screen 52: a program name display field 52d, a performer display field 52a, a selection field 52b for a viewer making selection on whether to make a contribution to this performance as an angel, and an amount entry field 52c for the viewer entering an amount of the contribution. The viewer enters a check in the selection field 52b when he/she wants to make a contribution to this performance as an angel, and freely enters an amount of the contribution in the amount entry field 52c.

In the program name display field 52d, the television station name, the broadcasting date/time, and the television program name are displayed based on the schedule information of the television program sent from the broadcast management system 600 to the performer assisting system 500, and characters of “Now accepting new angels” are displayed. In the performer display field 52a, the name (artist name) of the performer who is currently presenting a performance on the television program is displayed. It is desirable that the performer display field 52a, as illustrated in FIG. 13, includes a screen that displays a video image being broadcast, a thumbnail image of the performer, or the like, so that the viewer can confirm the performer. In addition, the performer's profile, comments, and the like may be displayed on the performer display field 52a, making the screen effective for attracting the interest of viewers. Incidentally, the number of angels at the moment and the total amount of contributions from angels may be displayed on the application screen 52.

The entry of a contribution amount is allowed by the end of the television program. Alternatively, making a contribution may be allowed even after the end of the television program, until a predetermined period of time has passed. Still alternatively, the configuration may be as follows: by linking the progress of the television program and the operation of the terminal 302, an “application time” is provided in the television program when all of the performances are finished, so that states of contributions from angels to respective performers are relayed real-time on the television screen.

When a contribution amount is entered on the application screen 52, contribution amount data together with information identifying the viewer are sent from the terminal 302 to the contribution acceptance unit 12. An amount of the contribution from an angel may be collected by electronic payment from the angel making the contribution, and an entirety or a part of the amount is paid to a performer as a compensation for the presentation of the performance (performance fee) by appearing on television.

The contribution acceptance unit 12, when receiving information that identifies the angel (viewer) and contribution amount data from the viewer's terminal 302, stores the same, together with information that identifies the performance as a contribution target (performance ID), in the data storage unit 17. The performance ID is an ID uniquely assigned to each performance by the system. This is similar to that described with reference to FIG. 3 in Embodiment 1, and therefore the descriptions of the same are omitted.

In the present embodiment as well, the recorded video distribution unit 13, as a motion picture distribution platform, distributes the recorded performance video. The distributed recorded video is uploaded from the television station or the performer to the performer assisting system 500, and is registered in the recorded video distribution unit 13. The recorded video for distribution may be the motion picture of the performance broadcast by television per se, or may be a motion picture that has been edited in a certain way by the performer or the television station.

As is the case with Embodiment 1, a viewer can watch the recorded performance video at the terminal 302 for free. It should be noted that upon the reproduction of the recorded performance video, advertisement is also displayed together, and advertising revenue from an advertiser according to the view count of the recorded performance video goes to the recorded video distributor. Upon every access to the recorded video distribution unit 13 for watching one recorded performance video, the charging unit 14 increments the view counter of the recorded performance video by one. The charging unit 14 calculates a revenue of recorded video distribution at a predetermined timing (for example, the last day of every month) per recorded performance video, by multiplying the view count in a target period by an advertisement unit price. Incidentally, the method for calculating the revenue of recorded video distribution is not limited to this, and any method such as a calculation method taking customer appeal of advertisement into consideration can be used. The revenue of recorded video distribution thus calculated is collected from an advertiser. At least a part of the revenue of recorded video distribution is divided among the performer and the angel.

In addition, as a configuration of the present embodiment as well, a configuration is shown in which the performer assisting system 500 incorporates the recorded video distribution unit 13 inside. As described in conjunction with Embodiment 1, however, the configuration can be such that the performer assisting system 500 does not have any function of the recorded video distribution unit 13 and outsources the recorded video distribution to an outside motion picture distribution platform. In this case, the performer assisting system 500 receives data of earnings based on the distribution of respective recorded performance videos, and calculates dividends to the performer and the angel in the dividend determination unit 15.

As described above, according to the present embodiment, the investment to a performer can be invited in a state of being linked with a television program. Conventionally, a new face scouting audition program has been widely known, which has provided obscure artists a chance to attract attention. Among such new face scouting audition programs, there is such a program that the winner is determined by voting from general viewers, but the viewers having voted do not get any return thereafter. In contrast, with the performer assisting system 500 according to the present embodiment, a viewer who makes a contribution to a performer (angel) can get, as a dividend, at least a part of revenue of recorded video distribution on later days. Thus, both of the performer and the viewer have advantages.

### Embodiment 6

The configuration of Embodiment 6 is such that a recorded performance video stored as a Video On Demand (VOD) in the recorded video distribution unit 13 is deleted from the recorded video distribution unit 13 in a case where the recorded performance video does not satisfy predetermined evaluation criteria at a point in time when a predetermined period of time has passed.

For example, after a recorded performance video is recorded in the recorded video distribution unit 13, the recorded video distribution unit 13 accumulates data for evaluation including: (1) the number of angles making contributions to the recorded performance video; (2) the total amount of contributions to the recorded performance video from angels; and (3) the number of views of the recorded performance video (the number of viewers or the number of viewing times). Incidentally, in (3), to the number of views of one recorded performance video, the number of views of the performance during live distribution may be added. Further, when one viewer watches the same recorded performance video a plurality of times, the number of a plurality of views as the gross number may be added. Still further, data for evaluation are not limited to (1) to (3) mentioned above, and other arbitrary data for evaluation may be used.

Then, at a point in time when a predetermined period of time (for example, one month) has passed since the recorded performance video is stored in the recorded video distribution unit 13, the recorded video distribution unit 13 determines whether or not to continue the distribution of the recorded performance video in future as well, based on the accumulated data for evaluation, with reference to the predetermined evaluation criteria. Incidentally, the predetermined period of time is not limited to one month described above, but any period of time can be set. Then, the recorded video distribution unit 13 deletes a recorded performance video that does not satisfy the evaluation criteria, and makes a notification to the performer (and the angel). This notification may be made before the deletion or after the deletion.

In this way, by deleting a recorded performance video that does not satisfy certain evaluation criteria after a predetermined period of time has passed, the capacity of the recorded video distribution unit 13 can be prevented from increasing unlimitedly. In addition, by deleting a recorded performance video that does not satisfy certain evaluation criteria, the quality of service can be maintained or improved.

Incidentally, the configuration may be such that the dividend determination unit 15 does not allocate dividends during the above-described predetermined period of time. In this case, regarding the recorded performance video the deletion of which is determined after the predetermined period of time has passed, no dividend is allocated to angels. In this way, the allocation of dividends may be carried out after a performance is determined to satisfy the evaluation criteria, and thereby it is possible to achieve an advantage that a trouble of repayment of dividends for a performance that does not satisfy the evaluation criteria and is deleted can be avoided.

### Other Embodiments

The above-described embodiments are merely examples for implementing the present invention. The present invention, therefore, is not limited to the above-described embodiment, and the above-described embodiment can be appropriately varied and implemented without departing from the spirit and scope of the invention. In addition, it is possible to combine and implement any of the above-described embodiments.

The invention disclosed herein can be described as follows.

A prior-investment-type performer assisting system according to the first configuration of the present invention is a prior-investment-type performer assisting system configured to be capable of communicating with a viewer terminal via a network, the performer assisting system including:
a contribution acceptance unit that, when an ad-hoc distributed performance is released in such a way that earnings are produced later on, during ad-hoc distribution of a performance or during a predetermined period of time after the ad-hoc distribution, accepts an application for purchase of a dividend right to the earnings from a viewer terminal; and
a dividend determination unit that determines a dividend from the earnings with respect to the dividend right purchaser,
wherein, when there are a plurality of dividend right purchasers, the dividend determination unit determines dividends based on the equity percentage of the dividend right of each purchaser, and
the equity percentage of the dividend right is determined in accordance with a compensation for the dividend right purchase.

With this first configuration, a viewer watches ad-hoc distributed performances, and can make a contribution (an application for purchase of a dividend right) to a performance the viewer likes. The dividend right purchaser can receive the dividend when the ad-hoc distributed performance is released in such a way that earnings are produced later on. The dividends that respective purchasers can receive are determined based on the equity percentages of the dividend right. This makes it possible to provide a prior-investment-type performer assisting system with which it is possible to make prior investment intended to obtain dividends in future to an ad-hoc distributed performance, instead of paying a single view charge or support money to the performance. This makes it possible to pay, to a performer, at least a part of compensation that viewers paid when purchasing dividend rights, even in a situation where any real live performance with audience cannot be held. With the present system, therefore, both of a performer and a dividend right purchaser can continuously receive profits based on later release of a performance, instead of receiving profits only once upon ad-hoc distribution of the performance.

A prior-investment-type performer assisting system according to the second configuration has the first configuration further characterized in that:
ad-hoc distribution is live relay broadcast of a performance; and
the way in which earnings are produced is distribution of recorded live relay broadcast, and the earnings are a view charge for the recorded video distribution or an advertisement charge during the recorded video distribution.

With this second configuration, by ad-hoc distribution of live relay broadcast of a performance, a contributor (angel) can be recruited from viewers who watch the live relay broadcast. In addition, by recording the live relay broadcast of the performance and distributing the recorded video on later days, continuous profit allocation can be executed to both of the performer and the angel, funded by the view charge and the advertisement charge.

A prior-investment-type performer assisting system according to the third configuration has the first configuration further characterized in that:
the dividend right is a right to apply advertisement when a performance is released in such a way that earnings are produced later on; and
when there are a plurality of dividend right purchasers, the dividend determination unit determines advertisement appearance frequency based on the equity percentage of the dividend right of each purchaser.

With the third configuration, an advertiser who has watched ad-hoc distribution, by purchasing a dividend right of a performance that he/she likes, can acquire a right to apply advertisement when the performance is released later on. In addition, when there are a plurality of dividend right purchasers, advertisement appearance frequency is determined according to the equity percentage of the dividend right of each purchaser, whereby equitability can be secured among dividend right owners.

A prior-investment-type performer assisting system according to the fourth configuration has any one of the first to third configurations further characterized in that:
a performance is presented by a group of a plurality of performers;
the contribution acceptance unit accepts respective contributions to the plurality of performers of the group individually; and
the dividend determination unit determines dividends based on percentages of the contributions for the respective performers with respect to a total amount of contributions for the group as a whole.

With the fourth configuration, for a group composed of a plurality of performers, support can be made individually to a favorite specific performer. This makes it possible to improve supporters' satisfactions, and at the same time to increase the allocation to a more popular performer, which improves motivation of performers.

A prior-investment-type performer assisting system according to the fifth configuration has any one of the first to fourth configurations further characterized in that
the contribution acceptance unit carries out a two-stage auction to determine a dividend right purchaser; and
the two-stage auction includes:
   a first-stage auction for selecting participants in a second-stage auction, out of viewers who have applied for contributions; and
   a second-stage auction for determining the dividend right purchaser by carrying out a closed auction among the participants selected in the first-stage auction.

According to the fifth configuration, when it is necessary to narrow down candidates of the dividend right purchaser, the two-stage auction is carried out. More specifically, the second-stage closed auction is carried out among only the participants selected in the first stage, and the dividend right purchaser is determined. This therefore makes it possible to conceal the successful bidder and the successful bid price. This makes it possible to prevent the de facto price regarding the guaranteed fee for a performer from being established because of the disclosure of the successful bid price. This also has an advantage of protecting privacy of the successful bidder.

A prior-investment-type performer assisting system according to the sixth configuration has the configuration according to any one of the first to fifth configurations further characterized in including an ad-hoc distribution unit for ad-hoc distribution of a performance to a viewer terminal. This configuration requires a performer to only upload his/her own performance motion picture to enable ad-hoc distribution of the same from the system.

A prior-investment-type performer assisting system according to the seventh configuration has the configuration according to any one of the first to fifth configurations further characterized in that the ad-hoc distribution is broadcast as a television program by a television broadcast station. This configuration makes it possible to recruit dividend right purchasers in the linked manner with a television program.

A prior-investment-type performer assisting system according to the eighth configuration has the configuration according to any one of the first to seventh configurations further characterized in that: the distribution unit accumulates data for evaluation of the performance; after a predetermined period of time has passed, determines whether the performance satisfies predetermined evaluation criteria based on the data for evaluation; and deletes the recorded data of a performance that does not satisfy the evaluation criteria, from the data storage unit. This configuration makes it possible to suppress continuous increase of a storage capacity of the data storage unit. In addition, by deleting data of a recorded performance that does not satisfy the evaluation criteria, only good-quality performances are provided, whereby the quality of service can be maintained or improved.

In addition, a prior-investment-type performer assisting method executed by a computer, as one aspect of the present invention, includes the steps of:
distributing a performance in ad-hoc manner to a viewer terminal with which the computer is capable of communicating via a network;
when an ad-hoc distributed performance is released in such a way that earnings are produced later on, accepting an application for purchase of a dividend right to the earnings from a viewer terminal; and
determining a dividend from the earnings with respect to a dividend right purchaser,
wherein, when there are a plurality of dividend right purchasers, the dividends are determined based on the equity percentage of the dividend right of each purchaser, and
the equity percentage of the dividend right is determined in accordance with a compensation for the dividend right purchase.

In addition, a computer program as one aspect of the present invention is a computer-readable program for causing a computer to execute the steps of:
distributing a performance in ad-hoc manner to a viewer terminal with which the computer is capable of communicating via a network;
when an ad-hoc distributed performance is released in such a way that earnings are produced later on, accepting an application for purchase of a dividend right to the earnings from a viewer terminal; and
determining a dividend from the earnings with respect to a dividend right purchaser,
wherein, when there are a plurality of dividend right purchasers, the dividends are determined based on the equity percentage of the dividend right of each purchaser, and
the equity percentage of the dividend right is determined in accordance with a compensation for the dividend right purchase.

In addition, a computer-readable recording medium that stores the above-described computer program is also one aspect of the present invention.

### DESCRIPTION OF REFERENCE NUMERALS

100: performer assisting system
10: network
11: live relay unit
12: contribution acceptance unit
13: recorded video distribution unit
14: charging unit
15: dividend determination unit
16: communication unit
17: data storage unit
301: terminal
302: terminal

1. A prior-investment-type performer assisting system configured to be capable of communicating with a viewer terminal via a network, the system comprising:
a live relay unit for ad-hoc distribution of a performance;
a contribution acceptance unit that, when recorded data of the ad-hoc distributed performance are released in such a way that earnings are produced later on, during the ad-hoc distribution of the performance or during a predetermined period of time after the ad-hoc distribution, accepts an application for purchase of a dividend right to the earnings from a viewer terminal of a viewer who has watched the ad-hoc distributed performance;
a distribution unit that stores the recorded data of the ad-hoc distributed performance as earning-producing contents in a data storage unit, reads out the earning-producing contents from the data storage unit, and releases the contents on the network in such a way that earnings are produced; and
a dividend determination unit that determines a dividend with respect to the dividend right purchaser from the earnings obtained by the release of the earning-producing contents,
wherein, when there are a plurality of dividend right purchasers, the dividend determination unit determines dividends based on the equity percentage of the dividend right of each purchaser, and
the equity percentage of the dividend right is determined in accordance with a compensation for the dividend right purchase.

2. The prior-investment-type performer assisting system according to claim 1,
wherein the earnings are a view charge for the release of earning-producing contents, or an advertisement charge upon the release of the earning-producing contents.

3. The prior-investment-type performer assisting system according to claim 1,
wherein the dividend right is a right to apply advertisement when the earning-producing contents are released in such a way that earnings are produced later on, and
when there are a plurality of dividend right purchasers, the dividend determination unit determines advertisement appearance frequency based on the equity percentage of the dividend right of each purchaser.

4. The prior-investment-type performer assisting system according to claim 1,
wherein a performance is presented by a group of a plurality of performers, the contribution acceptance unit accepts respective contributions to the plurality of performers of the group individually, and
the dividend determination unit determines dividends based on percentages of the contributions for the respective performers with respect to a total amount of contributions for the group as a whole.

5. The prior-investment-type performer assisting system according to claim 1,
wherein the contribution acceptance unit carries out a two-stage auction to determine a dividend right purchaser, and
the two-stage auction includes:
a first-stage auction for selecting participants in a second-stage auction, out of viewers who have applied for contributions; and
the second-stage auction for determining the dividend right purchaser by carrying out a closed auction among the participants selected in the first-stage auction.

6. The prior-investment-type performer assisting system according to claim 1,
wherein the distribution unit accumulates data for evaluation of the performance; after a predetermined period of time has passed, determines whether the performance satisfies predetermined evaluation criteria based on the data for evaluation; and deletes the recorded data of a performance that does not satisfy the evaluation criteria, from the data storage unit.

7. A prior-investment-type performer assisting method executed by a computer that is a prior-investment-type performer assisting system configured to be capable of communicating with a viewer terminal via a network, the method comprising:
distributing a performance in ad-hoc manner;
when recorded data of the ad-hoc distributed performance are released in such a way that earnings are produced later on, during the ad-hoc distribution of the performance or during a predetermined period of time after the ad-hoc distribution, accepting an application for purchase of a dividend right to the earnings, from a viewer terminal of a viewer who has watched the ad-hoc distributed performance;
storing the recorded data of the ad-hoc distributed performance as earning-producing contents in a data storage unit, reading out the earning-producing contents from the data storage unit, and releasing the contents on the network in such a way that earnings are produced; and
determining a dividend with respect to the dividend right purchaser from the earnings obtained by the release of the earning-producing contents,
wherein, when there are a plurality of dividend right purchasers, the dividends are determined based on the equity percentage of the dividend right of each purchaser, and
the equity percentage of the dividend right is determined in accordance with a compensation for the dividend right purchase.

8. A non-transitory computer-readable medium including a program, for execution by a computer that is a prior-investment-type performer assisting system configured to be capable of communicating with a viewer terminal via a network, the program causing the computer to execute:
distributing a performance in ad-hoc manner;
when recorded data of the ad-hoc distributed performance are released in such a way that earnings are produced later on, during the ad-hoc distribution of the performance or during a predetermined period of time after the ad-hoc distribution, accepting an application for purchase of a dividend right to the earnings, from a viewer terminal of a viewer who has watched the ad-hoc distributed performance;
storing the recorded data of the ad-hoc distributed performance as earning-producing contents in a data storage unit, reading out the earning-producing contents from the data storage unit, and releasing the contents on the network in such a way that earnings are produced; and
determining a dividend with respect to a dividend right purchaser from the earnings obtained by the release of the earning-producing contents,
wherein, when there are a plurality of dividend right purchasers, the dividends are determined based on the equity percentage of the dividend right of each purchaser, and
the equity percentage of the dividend right is determined in accordance with a compensation for the dividend right purchase.

9. (canceled)
